(19) United States
(12) Patent Application Publication
(10) Pub. No.: US 2019/0211867 A1
(43) Pub. Date: Jul. 11, 2019

(54) SYSTEMS AND METHODS ASSOCIATED WITH A UTILITY HOOK

(71) Applicant: John Hohn, San Macros, TX (US)

(72) Inventor: John Hohn, San Macros, TX (US)

(21) Appl. No.: 16/224,084

(22) Filed: Dec. 18, 2018

Related U.S. Application Data
(60) Provisional application No. 62/616,145, filed on Jan. 11, 2018.

(51) Int. Cl. F16B 45/00; F16M 13/02

(52) U.S. Cl. CPC F16B 45/00; F16M 13/02

(57) ABSTRACT

Embodiments disclose a utility hook with a first end that is orthogonal to a second end, wherein a slanted shaft is positioned between the first end and the second end

### TECHNICAL FIELD

This disclosure relates generally to a utility hook which may assist in hanging objects. More specifically, embodiments disclose a utility hook with a first end that is orthogonal to a second end, wherein a slanted shaft is positioned between the first end and the second end.

### BACKGROUND

Various situations arise that require hanging objects from a structure, such as a wall. Conventionally, to hang the object to the structure, users sometimes permanently hang the object using wall nails, adhesives, etc.

Alternatively, users use conventional hangers to suspend the object on the wall. However, conventional hangers typically place the object directly adjacent to the wall. This may limit the surface area of the object exposed to the atmosphere. Situations may arise where it is desirable for a non-coupled end of the object to be positioned away from the wall, fence, etc., which will maximize the surface area of the object exposed to the atmosphere.

Accordingly, needs exist for more efficient and effective a utility hook utility hook with a first end that is orthogonal to a second end, wherein a slanted shaft is positioned between the first end and the second end.

### SUMMARY

Embodiments described herein disclose a utility hook configured to hang objects to a structural support, such as a chain link fence, pipe, hook, etc. The utility hook may be formed of a unitary piece of metal, plastic, composite material. For example, the utility hook may be formed of a heavy, rigid wire. Embodiments of the utility hook may include a first end, second end, and a shaft.

The first end of the utility hook may be configured to receive the object, wherein the object may be any device, such as a mop, hammer, household goods, business goods, industrial goods, etc. In embodiments, the first end of the utility hook may be configured to be inserted through a hole within a handle of the object, which may assist in securing the object. The first end of the utility hook may include a slanted sidewall, curved edge, hanging portion, and lip.

The slanted sidewall may extend from a proximal end of the shaft to the curved edge. The slanted sidewall may be angled away from the shaft at a slight angle, such that the second end of the utility hook is not co-planer with the slanted sidewall. This slight angle may allow the shaft to be positioned away from the structural support.

The curved edge may be positioned between the hanging portion and the slanted sidewall. The curved edge may be utilized to the level the hanging portion.

The hanging portion may be positioned between the curved end and the lip, wherein the hanging portion may be configured to support the object responsive to sliding the first end through an orifice of the object. The hanging portion may be positioned perpendicular to a first skewed sidewall of the second end, which may allow for the first end to be positioned orthogonal to the second end.

The lip may be positioned on an end of the hanging portion, wherein the lip may be configured to retain the object on the hanging portion. In embodiments, the lip may be angled towards the shaft, which may be away from a ground surface in use.

The second end of the utility hook may be positioned on a distal end of the shaft, wherein the second end of the utility hook may be configured to be temporarily affixed to the support structure. In embodiments, the second end of the utility hook may be positioned orthogonal to the first end of the utility hook. The relative positioning of the first and second end of the utility hook may allow the object to be hung on the support structure in a position that is away from the support structure. The second end of the device may include a first skewed sidewall, curved end, and second skewed sidewall.

The first skewed sidewall may be angled away from the shaft in a first angle. The first angle may be in a first direction relative to the first end.

The curved end may be positioned between the first skewed sidewall and the second skewed sidewall, wherein a first boundary of the curved end is positioned on a first side of the shaft and a second boundary of the curved end is positioned on a second boundary of the shaft. In embodiments, the curved end may form a semi-circle.

The second skewed sidewall may be positioned on the second boundary of the curved end, and extend in an angle that is parallel to the first angle. This may allow a distance between the first skewed sidewall and second skewed sidewall to remain constant. A first and second end of the second skewed sidewall may be positioned on the same side of the shaft. In embodiments, the first skewed sidewall and second skewed sidewall may have different lengths, wherein the length of the second skewed sidewall may be longer than that of the first skewed sidewall.

The shaft may be positioned between the first end and the second end. The shaft may extend in a direction that is coplanar to direction of the first end, and perpendicular to a plane associated with the second end. The shaft may have a given length that is shorter than that of the first angled sidewall and the second skewed sidewall, but larger than that of the first skewed sidewall. However, in other embodiments, the length of the shaft may vary relative to the other elements of the utility hook.

In embodiments, the dimensions associated with the first end, second end, and shaft may allow the object to freely hang on the support structure, without being positioned directly adjacent to the support structure.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention. The invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts a utility hook, according to an embodiment.

FIG. 2 depicts a front view of a utility hook, according to an embodiment.

FIG. 3 depicts a side view of utility a hook, according to an embodiment.

FIG. 4 depicts a perspective view of utility a hook, according to an embodiment.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The invention and the various features and advantageous details thereof are explained more fully with reference to the nonlimiting embodiments that are illustrated in the accompanying drawings and are detailed in the following description.

The word “exemplary” is used herein to mean “serving as an example, instance, or illustration.” Any embodiment described herein as “exemplary” is not necessarily to be construed as preferred or advantageous over other embodiments.

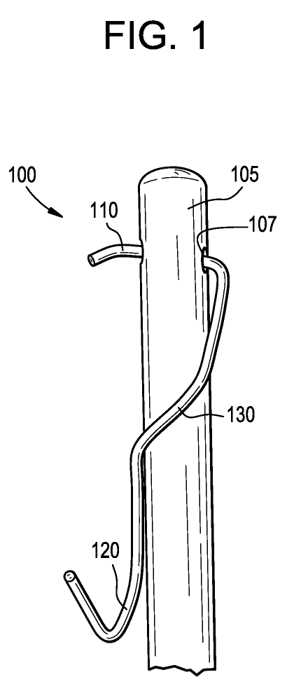

FIG. 1 depicts utility hook 100, according to an embodiment. As depicted in FIG. 1, utility hook 100 may be configured to be inserted through a hole 107 on a handle of an object 105. Responsive to inserting portions of utility hook 100 through hole 107, utility hook 100 may be temporarily coupled to object 105. This may allow, utility hook 100 to support object 105 if utility hook 100 is coupled to a support structure, such as a fence, wall, overhead pipe, etc. Utility hook 100 may include a first end 110, second end 120, and shaft 130.

Based on the dimensions of utility hook 100, second end 120 may be positioned away from an end of object 105, creating a space between second end 120 and object 105. This may allow for quicker and easier engagement of second end 120 with the support structure.

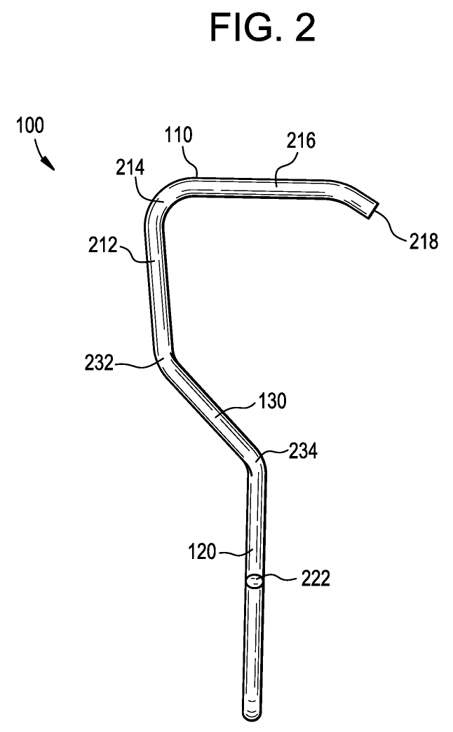

FIG. 2 depicts a front view of utility hook 100, according to an embodiment. As depicted in FIG. 2, first end 110 may include slanted sidewall 212, curved edge 214, hanging portion 216, and lip 218.

Slanted sidewall 212 may extend from a proximal end 232 of shaft 130 to curved edge 214. Slanted sidewall 212 may be angled away from shaft 130 at a slight angle, such that the second end 120 of the utility hook is not co-planer with Slanted sidewall 212. This slight angle may allow first end 110 to be positioned away from the structural support. In embodiments, the slight angle may be approximately five degrees. A first length of slanted sidewall may be approximately 1 and 9/16 inches.

Curved edge 214 may be positioned between hanging portion 214 and slanted sidewall 212. An angle associated with curved edge 214 and slanted sidewall 212 may form a complementary angle with respect to level hanging portion 216. This may allow hanging portion 216 to be positioned perpendicular, in a first plane, to a first skewed sidewall of the second end 120. For example, curved edge 214 may have a ninety five degree angle in a first direction, while slanted sidewall 212 may have a five degree angle in a second direction.

Hanging portion 216 may be positioned between the curved end 214 and the lip 218. Hanging portion 216 may be configured to support the object responsive to sliding first end 110 through an orifice of the object 105. Hanging portion 216 may have a second length, wherein the second length is less than the first length. For example, the second length may be 1½ inches long. In the first plane, a first end of hanging portion 216 may be positioned on a first side of second end 120, and a second end of hanging portion 218 may be positioned on a second side of second end 120. This may create a long enough length to support the object 105.

Lip 218 may be positioned on the second end of hanging portion 216. Lip 218 may be configured to retain the object 105 on hanging portion 216. Lip 218 may be configured to limit the horizontal movement of object 105 towards and end of lip 218. This may not allow object 105 to fall off first end 110. In embodiments, lip 218 may be angled towards shaft 130, which may be away from a ground surface in use. In further embodiments, the angle of the lip may be less than an angle of the shaft 130. For example, lip 218 may be angled at thirty degrees, while shaft 130 may be angled at one hundred thirty five degrees. In embodiments, lip 218 may have a third length, which is shorter than the first and second lengths. For example, lip 218 may be ¼ of an inch.

Shaft 130 may be positioned between first end 110 and second end 120. Shaft 130 may extend in a direction that is coplanar to direction of first end 110, and perpendicular to a plane associated with second end 130. Shaft 130 may have a fourth length that is shorter than the first length. For example, shaft 130 may have a length of 1 and ⅛ inches.

Second end 120 may be positioned on an opposite end of utility hook 100 as first end, and first end 110 and second ends may have substantially different shapes and orientations. The body of second end 120 may be substantially orthogonal to that of first end 110, such that the entirety of second end from the portion adjacent to shaft to distal end 222 of shaft is perpendicular to that of first end 110.

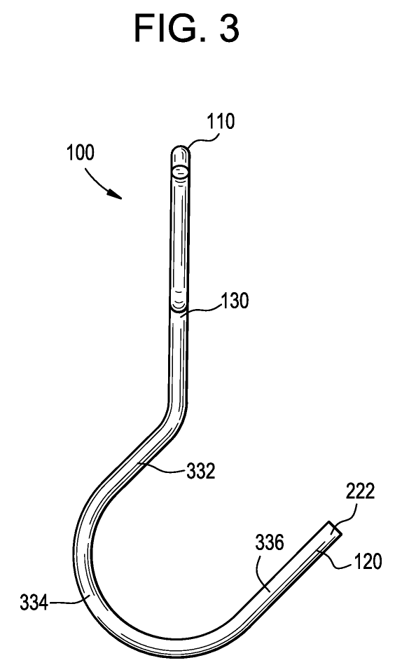

FIG. 3 depicts a side view of utility hook 100, according to an embodiment. Elements of FIG. 3 may be substantially described above. For the sake of brevity, a further description of these elements is omitted.

Second end 120 may be positioned on a distal end of shaft 130, and be configured to be temporarily affixed to the support structure. Second end 120 may be configured to extend in a different, second plane than first end 110, wherein the first and second planes are orthogonal to each other. The relative positioning of the first end 110 and second end 120 of utility hook 100 may allow the object to be hung on the support structure in a position that is away from the support structure. Second end 120 of the device may include a first skewed sidewall 332, curved end 334, and second skewed sidewall 120.

First skewed sidewall 332 may be angled away from the shaft in a first angle. The first angle may be in a first direction relative to the first end 110. In embodiments, the first angle may be an angle between thirty and sixty degrees, such as a forty five degree angle. In embodiments, first skewed sidewall 332 may have a fifth length, wherein the fifth length may be slightly less than 1 inch, such as 15/16 of an inch.

Curved end 334 may be positioned between first skewed sidewall 332 and the second skewed sidewall 334. A first end of the curved end may be positioned on a first side of the shaft 130 in the second plane, and a second end of the curved end is positioned on a second boundary of the shaft 130 in the second plane. In embodiments, curved end 334 may extend one hundred eighty degrees, and have a one inch radius. The size and shape of curved end 334 may allow second end 120 to be easily positioned over a support structure. In embodiments, the opening created by curved end 334 may create a distance of approximately two inches between the skewed sidewalls, 332, 336.

Second skewed sidewall 336 may be positioned on the second boundary of the curved end 334, and extend in a second angle that is parallel to the first skewed sidewall 332. Second skewed sidewall 336 may have a sixth length, which may be approximately one and a half inches.

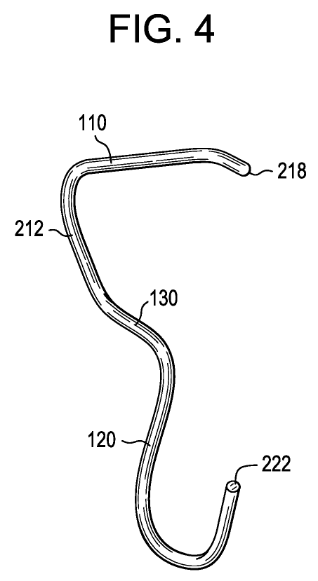

FIG. 4 depicts a perspective view of a utility hook, according to an embodiment.

In the foregoing specification, embodiments have been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of the invention.

Descriptions of well-known starting materials, processing techniques, components, and equipment are omitted so as not to unnecessarily obscure the invention in detail.

It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having,” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of any term or terms with which they are utilized. Instead, these examples or illustrations are to be regarded as being described with respect to one particular embodiment and as being illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” and “in one embodiment.”

Although the invention has been described with respect to specific embodiments thereof, these embodiments are merely illustrative, and are thus not restrictive of the invention. The description herein of illustrated embodiments of the invention is not intended to be exhaustive or to limit the invention to the precise forms disclosed herein (in particular, the inclusion of any particular embodiment, feature, or function is not intended to limit the scope of the invention to such embodiment, feature, or function).

Rather, the description is intended to describe illustrative embodiments, features and functions in order to provide a person of ordinary skill in the art context to understand the invention without limiting the invention to any particularly described embodiment, feature, or function. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes, and substitutions are intended in the foregoing disclosures. It will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A utility hook comprising:
a shaft that is slanted in a first plane at a first angle;
a first end that is coupled to a first boundary of the shaft, the first end including a slanted sidewall that is slanted in the first plane at a second angle, a curved edge, and a hanging portion, wherein a lip is positioned on a distal end of the hanging portion;
a second end that is coupled to a second boundary of the shaft, the second end being positioned orthogonal to first end, the second end including a first skewed sidewall and a second skewed sidewall that are positioned in parallel to each other.

2. The utility hook of claim 1, wherein the curved edge has a third angle, wherein the second angle and the third angle are complementary.

3. The utility hook of claim 2, wherein the lip has a fourth angle, the fourth angle being greater than the third angle.

4. The utility hook of claim 1, wherein a proximal end of the hanging portion is positioned on a first side of the shaft in the first plane, and the distal end of the hanging portion is positioned on a second side of the shaft in the first plane.

5. The utility hook of claim 1, wherein the second end includes a curved end that is positioned between the first skewed sidewall and the second skewed sidewall.

6. The utility hook of claim 5, wherein a proximal end of the curved end is positioned on the first side of the shaft in a second plane, and a distal end of the curved end is positioned on the second side of the shaft in a second plane.

7. The utility hook of claim 6, wherein the second skewed sidewall is longer than the first skewed sidewall.

8. The utility hook of claim 6, wherein the second skewed sidewall is positioned at a forty-five degree angle relative to the shaft in the second plane.
